(19) United States
(12) Patent Application Publication
(10) Pub. No.: US 2013/0015886 A1
(43) Pub. Date: Jan. 17, 2013

(54) High Voltage, High temperature Semiconductor Driver for Switching Power semiconductor devices

(71) Applicant: Brant Ture Johnson, Concord, MA (US)

(72) Inventor: Brant Ture Johnson, Concord, MA (US)

(73) Assignee: Brant T. Johnson, Concord, MA (US)

(21) Appl. No.: 13/181,087

(22) Filed: Jul. 12, 2011

(51) Int. Cl. G05F 3/02

(52) U.S. Cl. 327/109

(57) ABSTRACT

The application discloses a novel way to provide an integrated circuit driver interface between a control device and semiconductor power devices that benefit from the drivers unique ability to provide positive and negative voltages that improve the switching characteristics of the power devices. This invention's unique construction allows it to operate at high voltages and high temperature to the benefit of multiple power conversion applications.

### BACKGROUND OF THE INVENTION

In the field of Electrical power conversion, there are a number of integrated circuit devices that sense a desired output voltage or current that becomes a feedback signal that controls the flow of electrical energy from an input to an output. By constantly monitoring the output and controlling the transfer of electrical energy, a regulated output may be maintained under different input line and output load conditions. Often, the control of the electrical energy requires switching of power semiconductor devices at high speed. The need to rapidly switch power devices leads to specialized products specifically designed to rapidly turn on and turn off Power devices. These specialized products are often called Drivers. Drivers often have high voltage and high temperature requirements that lend them to being manufactured by different processes and packaged in different packages than the lower power control electronics. This invention is a Driver that operates between the power control device and power semiconductors. Its position in a typical application is shown in FIG. 1.

FIG. 1 shows a block diagram that illustrates the relationship between a PWM controller, a high efficiency driver, which is the subject of this invention, and a typical output stage of power devices that are driven by the invention.

In FIGS. 1, U1 and U2 are power switching transistors configured in a typical power converter application.

A problem with existing drivers is they are designed to control power semiconductors that are switched on or off by a single polarity with respect to the devices' control terminal. In the example of Power MOSFETS, the devices are switched by a voltage applied to their control element (Gate) with respect to the MOSFETS source element. This control voltage may be positive (for N Channel FETS) or negative (for P channel FETS) but never both. In addition, the devices maybe enhancement mode (turned on by a positive voltage Gate to Source) or depletion mode (turned off by a voltage Gate to Source). In all cases the control voltage is either positive or negative with respect to the Source. A large number of gate drivers of different voltages and current producing ability exist which provide fast switching of various power semiconductors. However, prior art does not cover any drivers that can provide a control voltage that is both positive and negative with respect to a Source terminal. The only way existing drivers can deliver both positive and negative drive signals is to bias the whole driver at a negative voltage. This tactic is expensive and requires a separate negative power supply with attendant cost and complexity. With both positive and negative voltages that this invention provides a driver may be build that provides turnoff current that is more effective than a conventional driver that can only provide a ground referenced turn off transistor. For example, a conventional driver turnoff transistor may have an on state resistance to ground of 1 ohm. When the Gate voltage of the power device is at 0.5 Volts, the turnoff current will be 0.5 Amps. Since the current invention provides negative voltages, a current source arrangement such as shown in FIG. 3 may be implemented. In this figure, a negative voltage developed by the invention is used to set up a switched current source that passes through a driver output transistor and acts as turn off current for a power device labeled U17 in the drawing.

The on state resistance of U16 may be 2 ohms, and the current source can easily provide one ampere of current. The result of this is that when the gate of the power transistor U17 is at 0.5 volts, the turn off current will be 1 ampere or two times better than the conventional case and since the on state resistance of the FET delivering this current (U16) is two ohms the physical size of U16 will be 2 times smaller and therefore less expensive than in the conventional case. This simplified example is intended to illustrate how the invention improves the state of art of drivers. In an actual implementation, the currents will themselves be switched and the actual Rdson's of the devices differ from those in this example.

A further difficulty with generating dual polarity voltages within a conventional junction isolated integrated circuit is the parasitic devices that arise from having negative voltages with respect to substrate ground. These parasitic can cause device failure and greatly limit the ability of a conventional Integrated Circuit to provide dual voltages with respect to substrate ground. Finally, because junction current leakage doubles roughly every 10 degrees of temperature rise, conventional integrated circuits Drivers manufactured with junction isolation are limited to a maximum operating temperature around 150 Degrees C. In many power applications, it is desirable to be able to have drivers capable of higher operating temperatures.

### BRIEF SUMMARY OF THE INVENTION

The proposed invention advances current Driver art by using a unique means of generating voltages above and below the source voltages of the switching devices. The result is a driver that can more effectively switch power devices. Furthermore, the invention sidesteps the limitations of junction based integrated circuits by using dielectric isolation (D10) where a film of Silicon Dioxide (Glass) separates elements within the integrated circuit. The use of Dielectric Isolation provides over 400 volts of isolation breakdown voltage and furthermore can sustain that voltage at 200 degrees C. Finally, because the elements within the circuit are dielectrically isolated from one another, negative voltages can be produced without causing parasitic interaction with other elements within the circuit.

### DESCRIPTION OF THE FIGURES

FIG. 1 is a block diagram that shows the general topology of a power converter that uses the invention. Vin is the input voltage with respect to a second input called ground. The PWM controller processes this voltage and produces an electrical output. This output is often not appropriate for driving power devices which are shown as UI and U2 in the figure. The invention receives the output signals from the PWM controller and in a unique way alters them so as to be more efficient for switching U1 and U2.

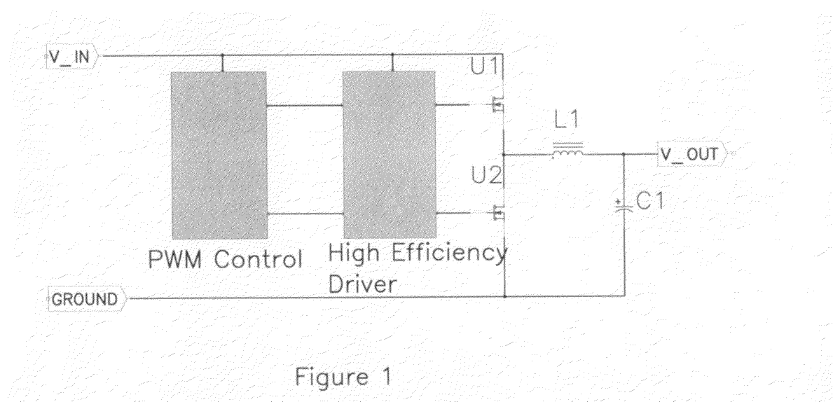

FIG. 2 Figure two is a more detailed schematic drawing of an embodiment of the invention that is shown only as a block in FIG. 1. FIG. 2 shows enough schematic detail to illustrate how the invention works.

FIG. 3 is a schematic drawing which is intended to show how the invention's producing a negative voltage helps produce a more efficient way of switching power devices.

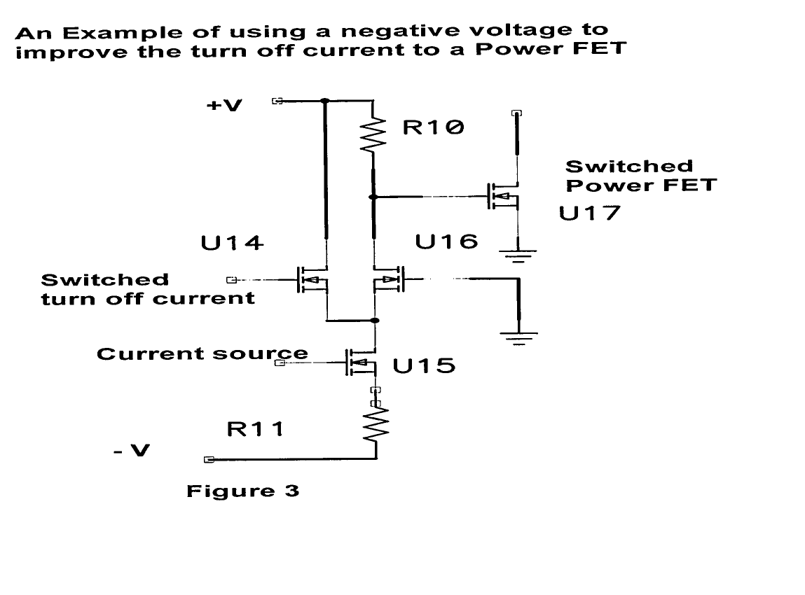

### DETAILED DESCRIPTION OF THE INVENTION

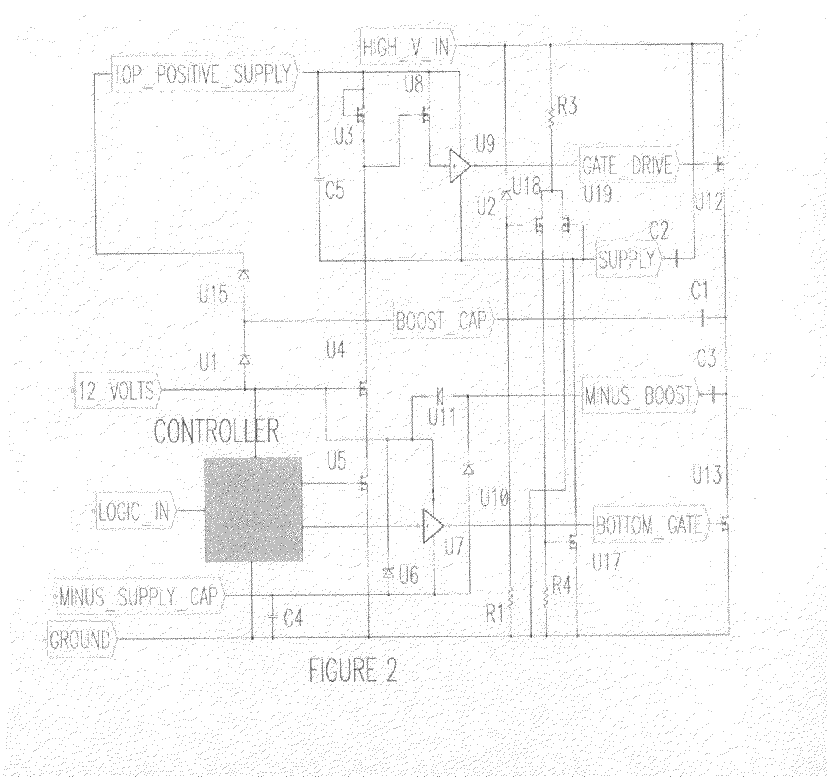

With reference to FIG. 2, there are 4 power sources that operate within the driver. These voltage sources are positive and negative with respect to the Sources of the bottom and top Power FETs (U13 and U12 respectively). The positive voltage source, used to turn on the bottom external FET (U13), is simply the 12 volt input low voltage bias supply (12_VOLTS). The negative supply for the bottom FET is derived from C3 which is attached to the switching node between U13 and U12 and the Diode U10. Diode U11 biases one side of the Bottom Boost cap to the +12 Volt low voltage input voltage (12_VOLTS). When the switch node goes negative, it forward biases U10 and develops a negative voltage on C4 (MINUS_VOLTGE_CAP). This voltage is clamped to −12 volts by a 24 volt Zener diode U6 which is connected to the +12 volt input supply. The top half of the Driver has similar arrangements that produce a positive and negative voltage with respect to the top FET's (U12) Source. C1 is a Boost cap that reacts to a positive switching transient by pushing a positive voltage through Diode U15. Diode U1 biases the capacitor at 12 volts so that the positive voltage after the switching transient will be 12 volts higher than the high voltage supply. The negative voltage with respect to the top Power FETS Source is generated by Zener diode U2 and R1. U2 in this example U2 is a 12 volt zener which creates voltage 12 volts below the high voltage input. P channel transistors U18, U19 and U17 form a differential amplifier that generates current that pulls down the voltage on capacitor C2. When the voltage on C2 gets below −12 volts with respect to the high voltage input, the differential amplifier stops delivering current. As soon as the voltage on C2 rises toward the high voltage input, U18 will conduct more differential current causing U17 to bring the voltage on C2 back to −12 volts. Once these voltages are established, the driver amplifiers can deliver either a turn on current or a turn off voltage or current to the power FETS. As pointed out in the general description, the advantage of the current sources is that they can provide switching currents all the way to zero volts with transistors smaller and therefore less expensive than required in the prior art

This embodiment of the invention is intended to cover all modifications and alternatives falling within the scope of the invention defined by the claims below.

What is claimed is:

1) A driver that by providing more appropriate gate bias to power devices produces more efficient operation of these devices.

2) A driver that produces both positive and negative gate bias for power switching devices.

3) A driver that uses the negative voltage sources to develop a current source that can provide more efficient turn off currents to the gates of power switching devices

4) A driver that uses the unique properties of dielectric isolation to achieve both positive and negative gate voltages to more efficient switching of Power devices.

5) A driver that uses the unique features of dielectric isolation to achieve high temperature operation beyond the capabilities of junction isolated products.

6) A driver that produces both positive and negative gate bias to more efficiently switch power devices such as silicon Carbide FETS and silicon Nitride FETS and other devices that can benefit from both polarity drive voltages with respect to their sources to more efficiently be switched.
